(19) United States
(12) Patent Application Publication
(10) Pub. No.: US 2017/0096181 A1
(43) Pub. Date: Apr. 6, 2017

(54) TRACK UNIT FOR GROUND WORK VEHICLE

(71) Applicant: CAMSO MANUFACTURING ITALY S.R.L., Milano (IT)

(72) Inventors: Riccardo CANOSSA, Revere (IT); Giuseppe TRATTA, Remedello (IT)

(73) Assignee: CAMSO MANUFACTURING ITALY S.R.L., Milano (IT)

(21) Appl. No.: 15/283,579

(22) Filed: Oct. 3, 2016

(30) Foreign Application Priority Data
Oct. 2, 2015 (IT) 102015000057497

(51) Int. Cl. B62D 55/084; B62D 55/06

(52) U.S. Cl. CPC B62D 55/084; B62D 55/06

(57) ABSTRACT

A track unit for ground work vehicle, which comprises a structure for supporting a driving wheel that transmits motion to a ground resting track; the track unit is designed to be mounted as an alternative to a wheel at the end of at least one axle of the work vehicle that is provided with a motor drive unit designed with such characteristics as to give the machine correct values of the transmission ratio, i.e., of the travel speed in the configuration in which wheels are mounted at the ends of the axle; the track unit further comprises a speed-increasing gear system interposed between a hub, designed to be connected to a flange of the axle of the work vehicle, and the driving wheel that moves the track.

The present invention relates to a track unit for ground work vehicle.

As is known, in the use of ground work vehicles, such as for example tractors or machines that harvest agricultural products, such as combine harvesters or the like, it is often necessary, due to functional reasons linked to the characteristics of the ground or to the type of operations to be performed, to mount alternately, at the ends of at least one axle of the machine, simple wheels or track units.

Typically, the track units used on these machines comprise a supporting structure for a driving wheel, which is designed to move a track arranged in contact with guiding wheels and ground resting rollers which are associated with the same supporting structure.

Ground work vehicles of the type cited above are normally provided with a motor drive unit which is structured to give the machines values of the transmission ratio, i.e., of the translation speed, that are correct when the machines are in the configuration with simple wheels.

Upon transition, in the alternation cited above, to the presence of track units according to the background art, the transmission ratio of the axle is reduced considerably due to the reduction of the diameter of the driving wheel of the track units with respect to the diameter of the wheels, with consequent reductions of the maximum forward travel speed and incorrect synchronization between the axles of the machine when the original wheels are mounted on at least one of them, as in the typical case of track units mounted only on the rear axle of the tractor.

The aim of the present invention is to provide a track unit that can be mounted detachably on the end flanges of an axle of a ground work vehicle as an alternative to a simple wheel without the interposition of transmission boxes and without touching the motor drive unit of the machine, any variations of the transmission ratio of the machine remaining substantially absent.

Within this aim, an object of the present invention is to provide a track unit that is capable of offering the greatest assurances of reliability and safety in operation.

Another object of the invention is to provide a track unit that has a simple structure and is competitive from the economic standpoint.

This aim, as well as these and other objects that will become better apparent hereinafter are achieved by a track unit for ground work vehicle, according to the invention, as defined in claim 1.

Further characteristics and advantages of the present invention will become better apparent from the description of some preferred but not exclusive embodiments of the track unit according to the invention, illustrated by way of nonlimiting example in the accompanying drawings, wherein:

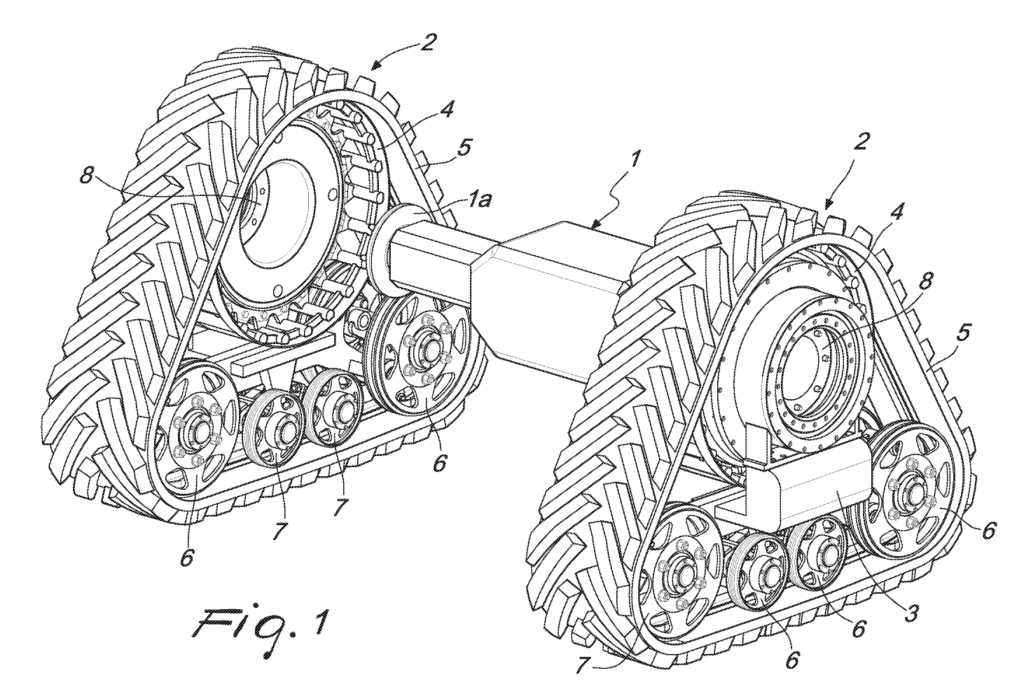

FIG. 1 is a perspective view of an axle of a work vehicle provided with track units according to the invention in a first embodiment thereof;

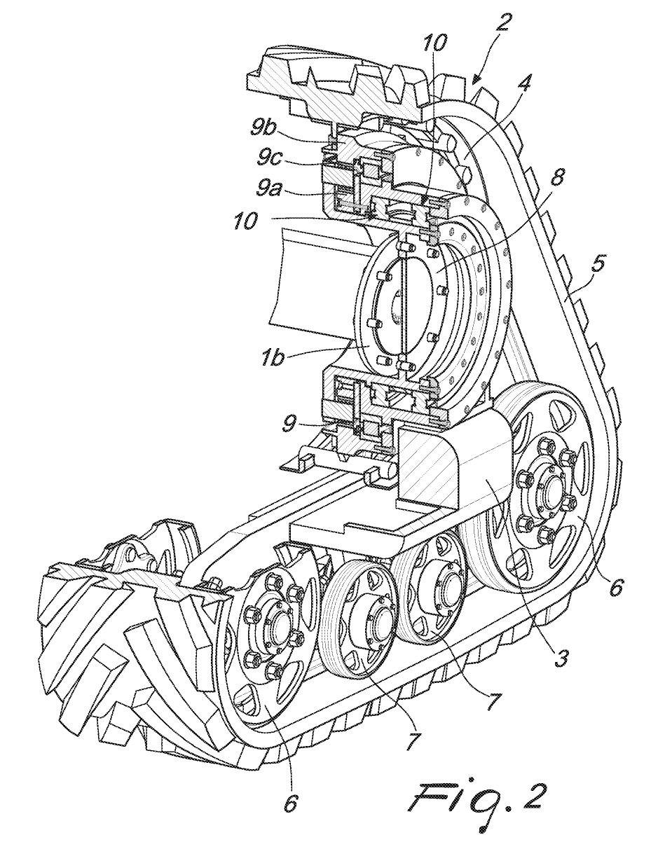

FIG. 2 is a partially sectional perspective view of a track unit according to the embodiment of FIG. 1;

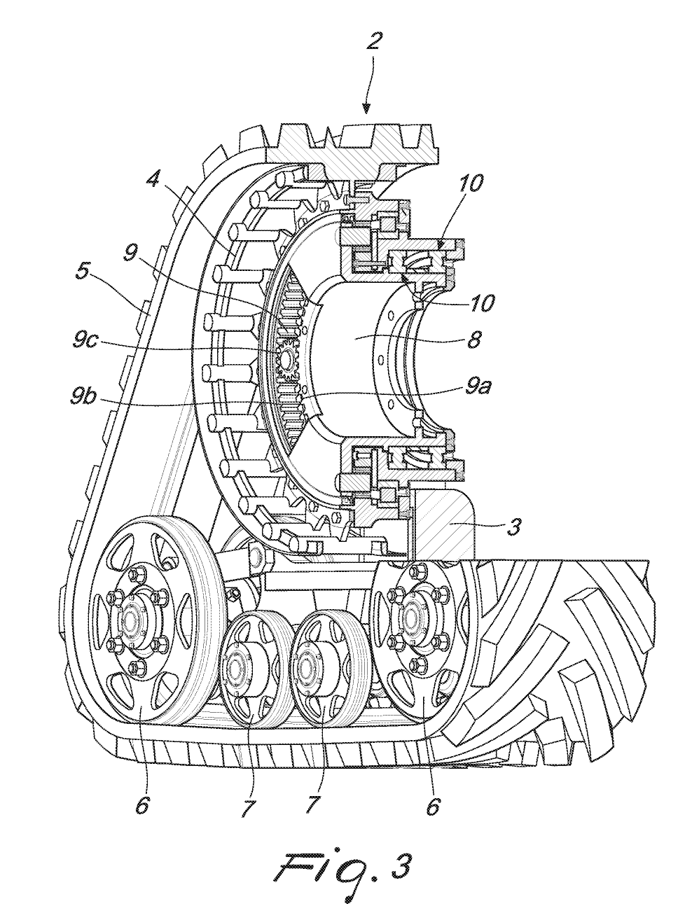

FIG. 3 is a different partially sectional perspective view of the track unit according to the embodiment of FIG. 1;

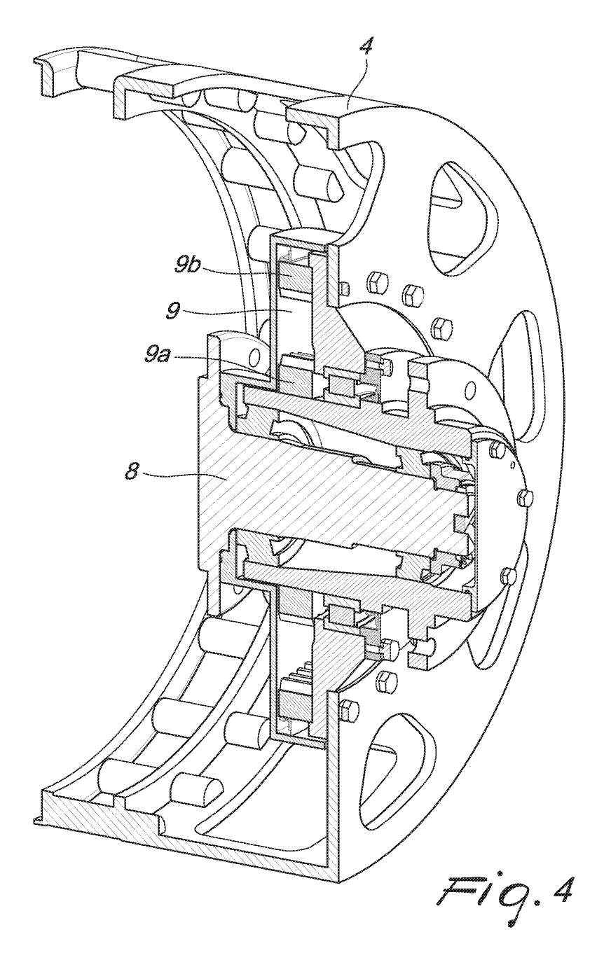

FIG. 4 is a partial sectional perspective view of a second embodiment of the track unit according to the invention;

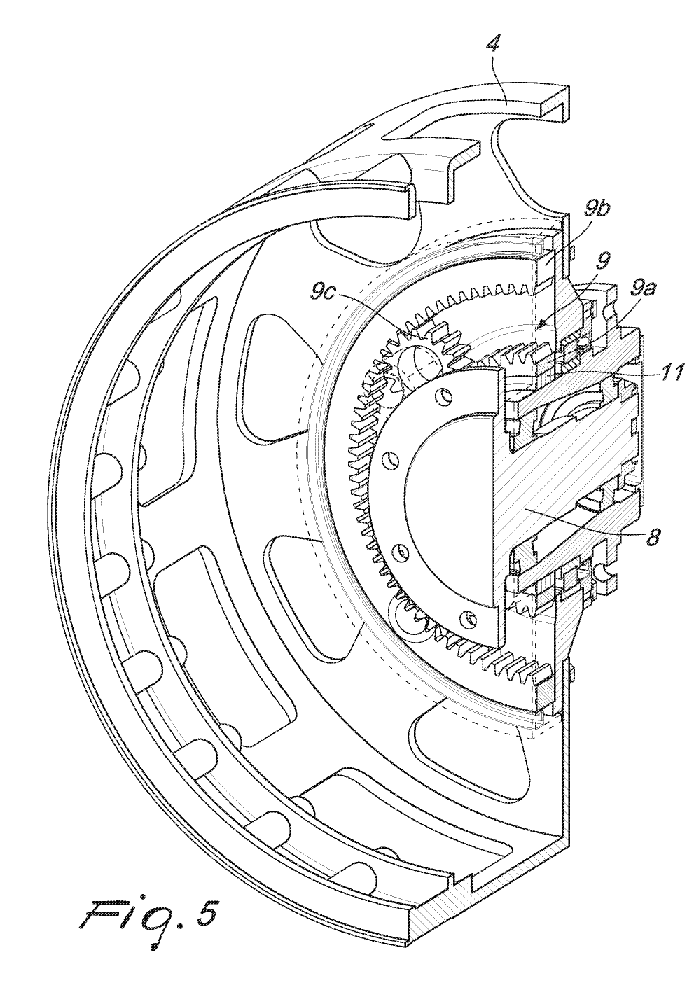

FIG. 5 is a perspective view, taken from a different angle and partially in cross-section, of a portion of the second embodiment of the track unit according to the invention, with parts shown in phantom lines in order to show the interior thereof;

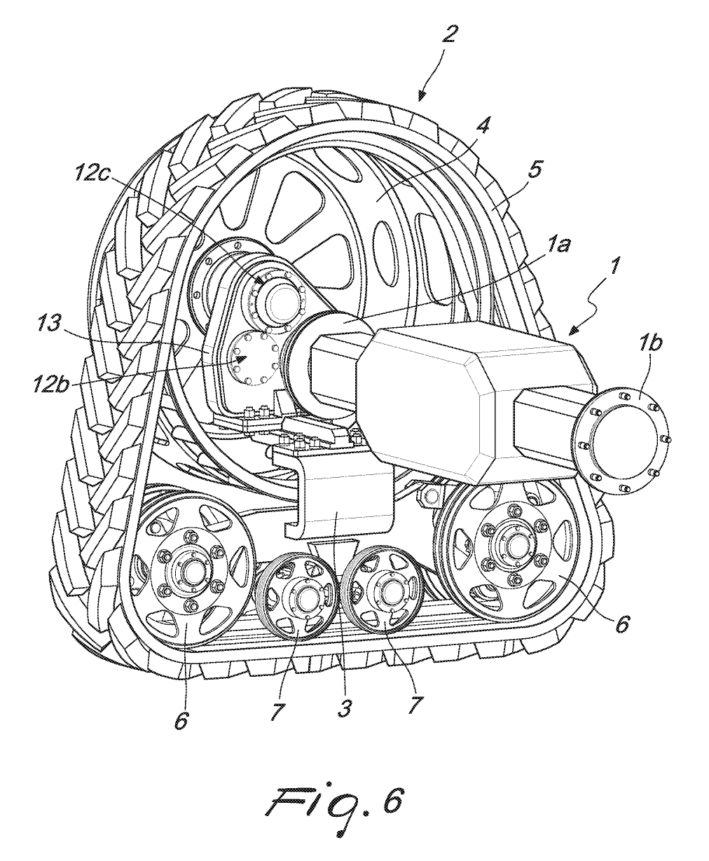

FIG. 6 is a perspective view of an axle of a work vehicle with a track unit according to the invention in a third embodiment;

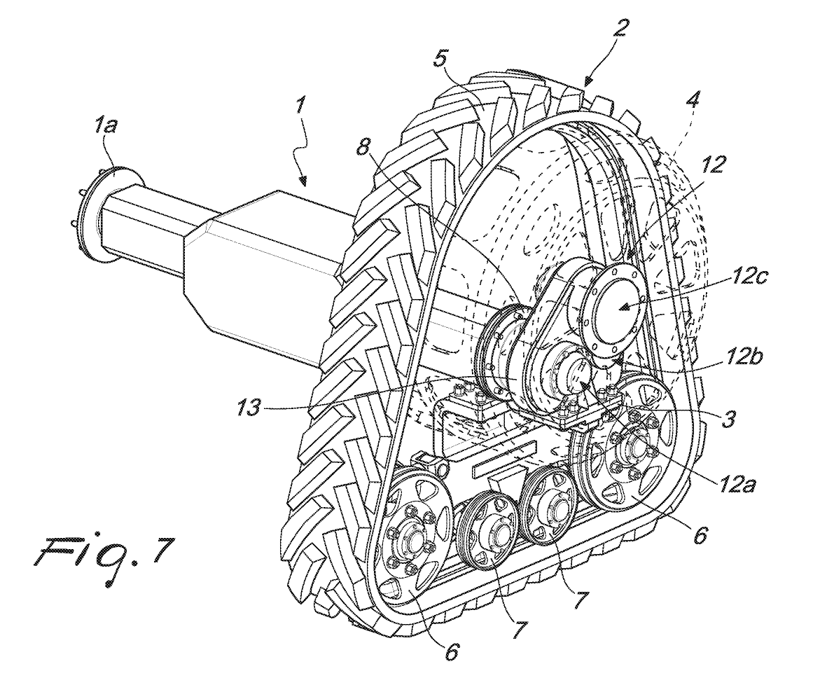

FIG. 7 is a perspective view of the track unit according to the invention in the third embodiment, taken from another angle and with a driving wheel shown in phantom lines;

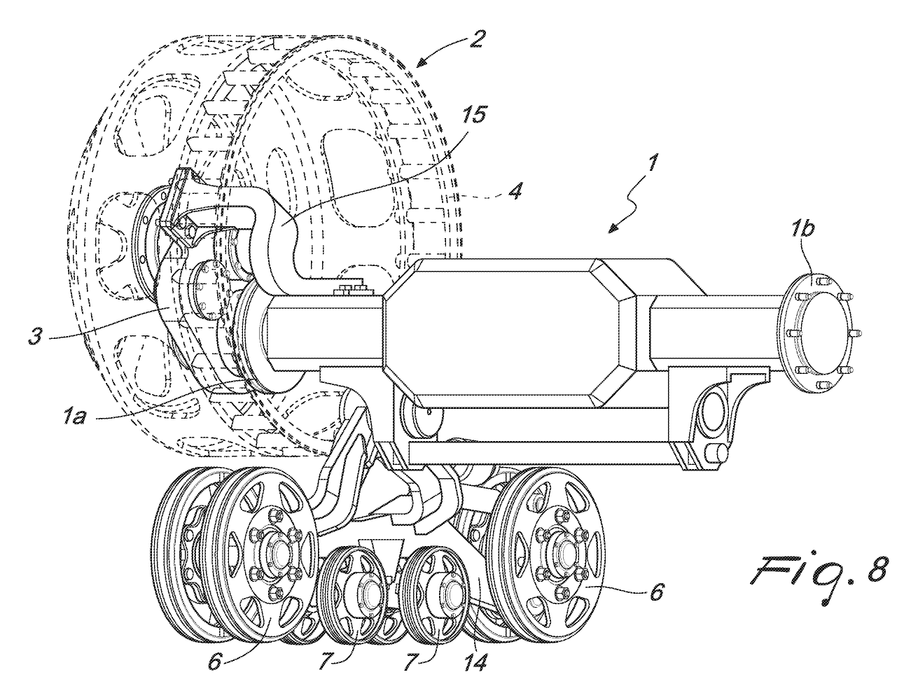

FIG. 8 is a perspective view of an axle of a work vehicle provided with the track unit according to the invention in the third embodiment, with parts omitted and others shown in phantom lines and with a reaction arm coupled to an element associated with the work vehicle.

With reference to the figures, the reference numeral 1 designates an axle of a work vehicle, with which two mirror-symmetrically identical track units 2 are associated.

The axle 1 is designed to be rotationally actuated about its own axis by a motor drive unit connected to the work vehicle.

Each track unit 2 comprises a supporting structure 3 for a driving wheel 4 that is designed to move a track 5, which is arranged in contact with guiding wheels 6 and ground resting rollers 7, which are associated, according to one possible embodiment, with the structure 3.

With reference in particular to FIG. 2, each track unit 2 is provided with a corresponding hub 8 in order to allow its connection to the axle 1.

More particularly, the axle 1, as per se known, is provided, at its two opposite ends, with flanges 1a, 1b, which are entrusted with the function of supporting a respective track unit 2, by means of the coupling with the corresponding hub 8, as an alternative to simple wheels, without, it is important to note, undergoing any change.

With reference to FIG. 3, the hub 8 is designed to support the structure 3 of the track unit 2 by means of bearings 10 and is connected to the driving wheel 4 by means of an angular speed-increasing gear system, constituted advantageously, according to the example of FIG. 3, by an epicyclic gear system 9, which has the function of increasing the rotation rate from the hub 8 of the track unit 2, which constitutes its input, to the driving wheel 4, which constitutes its output.

In greater detail, the epicyclic gear system 9 advantageously has a sun gear 9a, which is integral with the structure 3, a ring gear 9b, which is substantially coaxial to the hub 8 and integral with the driving wheel 4 of the track unit 2, and at least one pair of planet gears 9c, which mesh with the sun gear 9a and with the ring gear 9b. With reference again to the example of FIGS. 2 and 3, the planet gears 9c are advantageously supported, at the corresponding rotation pivot, by the hub 8.

The presence of the epicyclic gear system 9 allows to compensate the reduction factor of the transmission ratio, i.e., of the translation speed of the work vehicle, in the configuration with track units 2 with respect to the configuration with simple wheels, which is due to the smaller diameter of the driving wheel 4 of the track units 2 with respect to the diameter of the wheels, thus achieving a substantial equality of the values of the transmission ratio, i.e., of the speed, in the two configurations.

With reference again to FIG. 3, the sun gear 9a of the epicyclic gear system 9, being its reaction element, can advantageously be rendered integral with the structure 3 of the track unit 2 with the interposition of a torque limiter safety coupling 11, shown schematically in FIG. 5, in order to eliminate the motor moment peaks that might cause damage to the internal transmission teeth of the track 5.

For example, the safety coupling 11 can be constituted by a pack of disks which are preloaded axially according to the maximum transmissible torque.

It should be noted that in general the safety coupling 11 can be associated with at least any one of the elements that constitute the angular speed-increasing gear system.

Operation of the truck unit according to the invention is as follows.

The axle 1 turns the hubs 8 of the track units 2 that have been connected detachably to the flanges 1a, 1b, arranged at its opposite ends, as an alternative to simple wheels.

The meshing of the sun gears 9a with the corresponding planet gears 9c of the epicyclic gear systems 9 associated with the track units 2 and the driving of the rotation pins of the planet gears 9c by the hubs 8 causes the rotation of the ring gears 9b that are integral with the driving wheels 4 with a higher angular velocity than the angular velocity of the axle 1, with a consequent multiplication of the rotation rate and compensation of the reduction of the transmission ratio in the transition from the configuration with simple wheels to the configuration with the track units 2.

In practice it has been found that the invention is capable of achieving fully the intended aim and objects.

All the characteristics of the invention indicated above as advantageous, convenient or the like may also be omitted or be replaced with equivalents.

The individual characteristics presented with reference to general teachings or to particular embodiments may all be present in other embodiments or may replace characteristics in these embodiments.

The invention thus conceived is susceptible of numerous modifications and variations, all of which are within the scope of the appended claims.

Thus, for example, FIGS. 4 and 5 show a constructive variation in which, as a supporting element of the track unit 2, there is a hub 8 that has a spindle-like shape, instead of the hub 8 with an open configuration of the preceding example.

According to a third constructive variation, shown in FIGS. 6 and 7, if the driving wheel 4 must be arranged off-axis with respect to the input of the transmission, i.e., to the axle 1 of the work vehicle, the angular speed-increasing gear system can be constituted by an ordinary gear system 12, for example with three shafts.

More particularly, the ordinary gear system 12 conveniently comprises a first shaft 12a, which is provided with a first gear and is integral with the hub 8 that is connected to a respective flange 1a, 1b of the axle 1, a second shaft 12b, which is supported by a supporting body 13 which is connected, conveniently, to the structure 3 of the track unit 2 and is provided with a second gear that engages the first gear connected to the hub 8, and a third shaft 12c, which is integral with the driving wheel 4 and is provided with a third gear that engages the second gear.

In a further embodiment, shown in FIG. 8, there is a structure 3 for supporting a driving wheel 4 that is provided with an angular speed-increasing gear system, such as for example an ordinary gear system 12, and is not supported by a second supporting structure 14 of the guiding wheels 6 and ground resting rollers 7, the reaction of the gear system being absorbed by a coupling element, constituted for example by a reaction arm 15, which is associated with the work vehicle and is connected to the supporting body 13 or to the structure 3.

In practice, the materials used, so long as they are compatible with the specific use, as well as the shapes and dimensions, may be any according to the requirements.

All the details may furthermore be replaced with other technically equivalent elements.

The disclosures in Italian Patent Application No. 102015000057497 (UB2015A004182) from which this application claims priority are incorporated herein by reference.

What is claimed is:

1. A track unit for ground work vehicle, comprising a structure for supporting a driving wheel adapted to transmit motion to a ground resting track, said track unit being designed to be mounted as an alternative to a wheel at the end of at least one axle of said work vehicle that is provided with a motor drive unit designed with such characteristics as to give correct values of the transmission ratio in the configuration in which wheels are mounted at the ends of the axle, comprising a hub designed to be associated detachably with said axle, between said hub and said driving wheel there being a speed-increasing gear system in order to provide the axle with a suitable transmission ratio, typically similar to that with the wheeled configuration.

2. The track unit according to claim 1, wherein a torque limiter safety coupling is associated with at least one of the elements of said speed-increasing gear system in order to eliminate the motor moment peaks that might damage the internal transmission teeth of the track.

3. The track unit according to claim 1, wherein said speed-increasing gear system comprises an epicyclic gear system.

4. The track unit according to claim 3, wherein said epicyclic gear system comprises a sun gear, integral with said structure, a ring gear, substantially coaxial to said hub and integral with said driving wheel, and at least one pair of planet gears, which mesh with said sun gear and with said ring gear.

5. The track unit according to claim 1, wherein said speed-increasing gear system comprises an ordinary gear system.

6. The track unit according to claim 5, wherein said ordinary gear system comprises a first shaft, provided with a first gear and integral with said hub, a second shaft supported by a supporting body and provided with a second gear that meshes with said first gear, and a third shaft, which is integral with said driving wheel and is provided with a third gear that meshes with said second gear.
